(19) United States
(12) Patent Application Publication
(10) Pub. No.: US 2020/0270107 A1
(43) Pub. Date: Aug. 27, 2020

(54) ADJUSTABLE AIRCRAFT MAINTENANCE STAND

(71) Applicant: HHI CORPORATION, Ogden, UT (US)

(72) Inventors: Clifford R. HOKANSON, Kaysville, UT (US); Timothy Craig BRENNER, JR., North Salt Lake, UT (US); Steven M. BROWN, Ogden, UT (US)

(73) Assignee: HHI CORPORATION, Ogden, UT (US)

(21) Appl. No.: 16/797,255

(22) Filed: Feb. 21, 2020

Related U.S. Application Data
(60) Provisional application No. 62/810,465, filed on Feb. 26, 2019.

(51) Int. Cl. B66F 11/04; E04G 5/08; E04G 5/10; E04G 5/14

(52) U.S. Cl. CPC B66F 11/04; E04G 5/08; B64F 5/40; E04G 5/142; E04G 5/10

(57) ABSTRACT

A portable aircraft maintenance stand includes a frame assembly and a deck. The frame assembly has a base portion and an upper portion. The deck is mounted to the upper portion of the frame assembly and includes a cantilevered portion. The deck also has a gap configured to receive an engine of an aircraft such that the deck at least partially wraps around the engine. The cantilevered portion of the deck is configured to be positioned vertically above a wing of the aircraft while the base portion of the frame assembly is positioned vertically below the wing.

### RELATED APPLICATIONS

This application claims the benefit of the filing date of U.S. Provisional Application No. 62/810,465, filed on 26 Feb. 2019, and entitled ADJUSTABLE AIRCRAFT MAINTENANCE STAND, the disclosure of which is incorporated in its entirety by this reference.

### TECHNICAL FIELD

The present disclosure relates generally to maintenance stands, and more particularly to portable maintenance stands for use with aircraft engines, such as vertically oriented aircraft engines.

### BACKGROUND

Typically, aircraft maintenance stands fall into three categories: phase maintenance stands for depot-level maintenance, daily maintenance stands, and multi-application work stands. The type of required maintenance dictates the type of work platform required, and the level of skill that a mechanic must have to accomplish the designated task and to do so according to prescribed safety standards.

It is known in the aviation industry that aviation mechanics maintain aircraft airframe and structural components, flight surfaces, as well as maintaining hydraulic and pneumatic controls and actuating systems and mechanisms. The mechanics may also service landing gear systems, perform engine maintenance, air conditioning, pressurization, visual improvement, oxygen and other utility systems, egress systems, including seat and canopy ejection systems and components. Such detailed work requires facilitated access to the airplane component, which often rest at a high elevation. This work must be done in a safe and efficient manner.

Mechanics need to be able to service the aircraft from a work platform reaching elevated regions of the aircraft. Suitable, safe and efficient platforms for work on some types of vehicles are lacking in the art. A work platform which can be configured to be positioned in proximity to, for example, an airplane component, yet maintain a buffer to prevent bumping into the airplane component, is desirable and necessary to prevent damage to the aircraft. The work platform provides access to any tools, liquids, equipment, communication devices, and publications the mechanic may need, as well as access to the portion of the airplane which needs to be inspected and/or maintained.

In view of the foregoing, opportunities exist for improvements in maintenance platforms, particularly for certain types of aircraft with unique wing and engine configurations.

### SUMMARY

One aspect of the present disclosure relates to a portable aircraft maintenance stand that includes a frame assembly and a deck. The frame assembly has a base portion and an upper portion. The deck is mounted to the upper portion of the frame assembly and includes a cantilevered portion. The deck also has a gap configured to receive an engine of an aircraft such that the deck at least partially wraps around the engine. The cantilevered portion of the deck is configured to be positioned vertically above a wing of the aircraft, wherein the engine is mounted to the wing, while the base portion of the frame assembly is positioned vertically below the wing.

The upper portion of the frame assembly may be vertically adjustable relative to the base portion. The frame assembly may include first and second stair sections, at least one of the stair sections being automatically adjustable in response to the upper portion being adjusted vertically relative to the base portion. The frame assembly may further include a screw jack assembly operable to vertically adjust the upper portion relative to the base portion. The screw jack assembly may include at least four screw jacks that are linked together and operably concurrently using a single rotation input. The stand may also include a handrail assembly mounted to the deck, and the handrail assembly may include at least one height adjustable section. The handrail assembly may include at least one width adjustable member. The handrail assembly may include at least one removable section, such as a removable gate. The deck may include a plurality of deck sliders, and at least some of the deck sliders may be adjustable into and out of the gap to adjust a size of the gap. The engine may include a vertically oriented nacelle and a plurality of horizontally oriented rotor blades, and the deck may be positioned vertically below the rotor blades. The frame assembly may have a maximum width of less than about 15 feet and a maximum length of less than about 20 feet. The deck may be adjustable in height between about 15 feet and about 20 feet.

Another aspect of the present disclosure relates to a method of operating a portable maintenance stand relative to an aircraft. The aircraft has a wing and an engine mounted to the wing. The method includes providing a portable aircraft maintenance stand having a frame assembly and a deck. The deck is mounted to the frame assembly and has a gap. The method also includes positioning the stand adjacent to the aircraft with a portion of the deck positioned vertically higher than a top surface of the wing and a portion of the engine positioned in the gap.

The engine may include a vertically oriented nacelle and a plurality of horizontally oriented rotor blades, and the nacelle may be positioned in the gap while the deck is positioned vertically below the rotor blades. The deck may include a plurality of deck sliders, and the method may further include adjusting at least some of the deck sliders into and out of the gap to reduce a space between the deck and the engine within the gap. The frame assembly may include a base portion and an upper portion, the deck may be mounted to the upper portion, and the method may further include vertically adjusting the upper portion relative to the base portion to adjust a height of the deck relative to the aircraft. The frame assembly may include at least one flight of stairs, and the method may include automatically changing a pitch of the stairs when the upper portion is vertically adjusted relative to the base portion. The stand may further include a handrail assembly mounted to the deck, and the method may further include adjusting or removing a portion of the handrail assembly prior to and after positioning the portion of the engine in the gap.

Another aspect of the present disclosure relates to a portable aircraft maintenance stand that includes a horizontally oriented deck, a handrail assembly extending around a perimeter of the deck, a frame assembly supporting the deck, and at least one flight of stairs providing access to the deck. The deck is configured to at least partially extend around a nacelle of an engine of an aircraft and extend between a horizontally oriented rotor blade of the engine and a top surface of a wing of the aircraft. The frame assembly may be operable to vertically adjust a height of the deck.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a front perspective view of an aircraft maintenance stand in accordance with the present disclosure having a deck in a lowered position;

FIG. 2 is a right perspective view of the aircraft maintenance stand shown in FIG. 1;

FIG. 3 is a rear perspective view of the aircraft maintenance stand shown in FIG. 1;

FIG. 4 is a left perspective view of the aircraft maintenance stand shown in FIG. 1;

FIG. 5 is a partially exploded front perspective view of the aircraft maintenance stand shown in FIG. 1 with handrails in extended positions and a gate assembly and a screw jack assembly exploded from a frame assembly;

FIG. 6 is a front view of the aircraft maintenance stand shown in FIG. 1;

FIG. 7 is a rear view of the aircraft maintenance stand shown in FIG. 1;

FIG. 8 is a right side view of the aircraft maintenance stand shown in FIG. 1;

FIG. 9 is a left side view of the aircraft maintenance stand shown in FIG. 1;

FIG. 10 is a top view of the aircraft maintenance stand shown in FIG. 1;

FIG. 11 is a bottom view of the aircraft maintenance stand shown in FIG. 1;

FIG. 12 is a rear view of the aircraft maintenance stand shown in FIG. 1 with the deck in a raised position;

FIG. 13 is a perspective view of an aircraft with the aircraft maintenance stand of FIG. 1 positioned adjacent to an engine of the aircraft and with the handrails in lowered, retracted and/or removed positions;

FIG. 14 is a perspective view of one of the aircraft maintenance stands shown in FIG. 13 with the handrails in raised, extended and/or installed positions; and

FIG. 15 is a front view of the aircraft maintenance stand shown in FIG. 14.

While the embodiments described herein are susceptible to various modifications and alternative forms, specific embodiments have been shown by way of example in the drawings and will be described in detail herein. However, the exemplary embodiments described herein are not intended to be limited to the forms disclosed. Rather, the instant disclosure covers all modifications, equivalents, and alternatives falling within the scope of the appended claims.

### DETAILED DESCRIPTION

Maintenance stands are well known for purposes related to maintaining and repairing aircraft and other vehicles. Maintenance stands can be used for a variety of purposes, such as holding equipment and positioning workers in close proximity to the portion of the aircraft or other vehicle of interest.

Some types of aircraft, in particular, pose challenges related to maintenance because of the size, shape and/or location of portions of the aircraft that are being addressed by workers. Such is the case with the V-22 aircraft, which includes two propeller engines. A unique feature of the V-22 aircraft is that the engines can be rotated through a 90 degree angle to arrange the rotor blades either vertically to optimize forward movement of the aircraft, or horizontally to optimize vertical movement of the aircraft. When the V-22 aircraft is in a rest position on the ground, the engines automatically revert to a rest state in which the nacelle of the engine is arranged vertically and the rotor blades are arranged horizontally and at a location vertically at the top end of the engine. Further, the rotor blades may rotate to a predetermined rotated position when the engine is turned off with one rotor blade arranged in parallel with a length dimension of the fuselage of the aircraft and the other two arranged at an angle relative to the length dimension of the fuselage. When in this rest state, the rotor blades are positioned at least 20 feet above the ground and much of the engine that requires maintenance is positioned at least 10 feet above the ground and more typically in the range of 12 feet to 20 feet above the ground surface. The extreme height of the rotor blades and other portions of the engine as well as the vertically oriented nacelle and the horizontally oriented rotor blades pose significant challenges associated with accessing and performing maintenance and other tasks associated with the engines of a V-22 aircraft.

The present disclosure is directed to a maintenance stand, and in particular a maintenance stand that is portable and that provides a useful working environment for addressing maintenance and other tasks associated with a vehicle such as an aircraft. The stand may be positioned on or constructed to include a plurality of wheels, rollers or other devices that make it possible to more easily position the stand relative to the vehicle. In some embodiments, the stand may include a tow bar or other feature that makes it possible to more easily move the stand relative to the vehicle.

The stand may include a deck that provides a working surface upon which a plurality of workers may stand. The deck may be elevated relative to a ground surface on which the stand is supported. In at least some embodiments, the stand may include height adjustable features that move the deck up and down relative to the ground surface and the vehicle. The deck may be cantilevered from a frame structure that supports the deck. The cantilevered portion of the deck may make it possible to position the deck between various features of the vehicle such as, for example, over the top of a wing of an aircraft, between a nacelle and one or more rotor blades of an engine, or between an upper surface of a wing and one or more rotor blades or a nacelle of an engine of an aircraft.

The stand may also include one or more flights of stairs that facilitate access of the deck. At least one of the flights of stairs may be automatically adjustable (e.g., in pitch) to account for height adjustments of the deck. The stair treads of the one or more flights of stairs may remain parallel to a supporting ground surface during the automatic adjustment.

The stand may also include a handrail assembly. A portion of the handrail assembly may extend around an outer perimeter of the deck. Portions of the handrail assembly may also extend around the flights of stairs and associated landings for the flights of stairs. Some portions of the handrail assembly may be adjustable in height. Other portions of the handrail assembly may be temporarily removable. Still other portions of the handrail assembly may be horizontally adjustable. The handrail assembly may include gate structures that are pivotal between open and close positions. Some portions of the handrail assembly may include (e.g., covered by) protective or shock absorbing features such as rubber, foam, or the like to limit the risk of damage to the vehicle in the event that the handrail assembly contacts portions of the vehicle being worked on.

Another aspect of the disclosed stand relates to a gap or cutout in the deck. This gap may be sized to receive a portion of the vehicle being worked on such as, for example, a portion of a nacelle of an aircraft engine. The gap feature may facilitate the deck wrapping around a portion of the vehicle such as a vertically oriented nacelle of the V-22 aircraft. The deck may include a plurality of deck slider members that move into and out of the gap while the portion of the vehicle is positioned in the gap. The sliders may reduce the space between the deck and that portion of the vehicle positioned in the gap to provide an extension of the standing surface of the deck for the workers. The sliders may improve safety and/or provide an improved stability in and around the portion of the vehicle positioned with the gap. The sliders may include (e.g., covered by) protective or shock absorbing features (e.g., bumpers or the like) such as rubber, foam, or the like, particularly along surfaces of the sliders that may contact the vehicle, to limit the risk of damage to the vehicle in the event that the sliders contact portions of the vehicle being worked on. The sliders may also include positive stop features that limit the amount of movement of the sliders into or out of the gap, such as no further than half way across the width of the gap. Some of the sliders may include notched out portions to accommodate portions of the deck handrail assembly in some positions for the sliders.

In use, the stand may be adjusted into a preliminary or delivery state in which features of a stand are arranged and configured to permit moving the stand into a working position relative to the vehicle. Once the stand is in the working position, some features of the stand may be adjusted such that the stand is optimized for use during any work performed on the vehicle by workers using the stand. For example, portions of the handrail assembly may be lowered or removed when the stand is in the delivery position, and later adjusted into raised positions or other working orientations once the stand is in the working position (e.g., to accommodate the position of rotor blades for the V-22 aircraft). Further, the stand may be adjusted vertically once in the working position to position the deck at a more optimized position for the workers to perform certain tasks relative to various features of the vehicle.

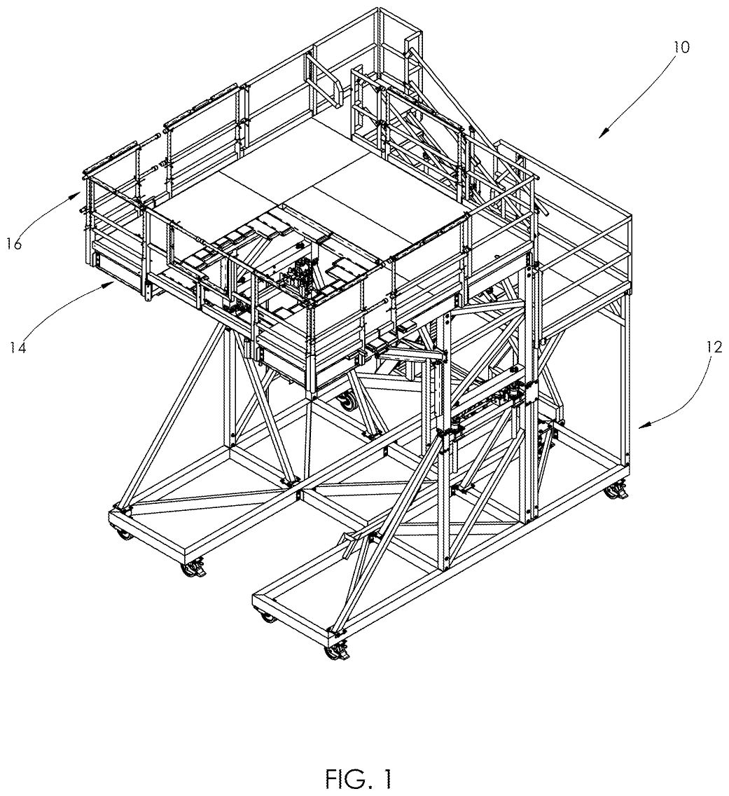

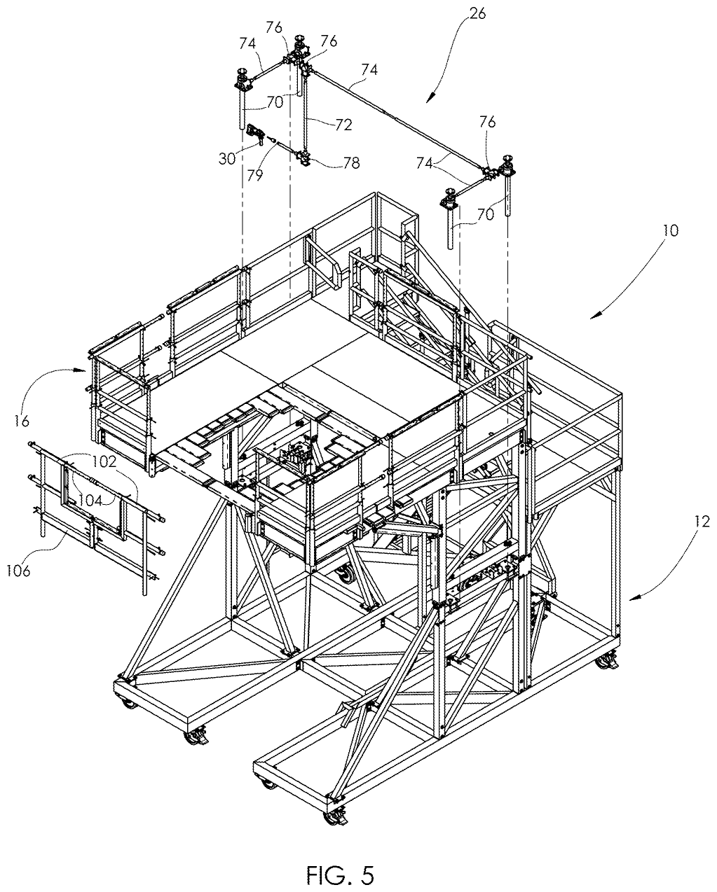

Referring now to FIGS. 1-4, an example aircraft maintenance stand 10 is shown in different perspective views. FIGS. 5-15 show the stand 10 in additional plan and perspective views. The stand 10 includes a frame assembly 12, a deck 14, and a deck handrail assembly 16. FIGS. 1-4 illustrate the stand 10 in a lowered position with all portions of the handrail assembly 16 in raised, extended and/or operational positions. The stand shown at FIGS. 1-4 illustrates one orientation for the stand 10 typical for when the stand is positioned adjacent to a vehicle and ready for use by workers to perform maintenance or other tasks associated with the vehicle using the stand 10. Other figures of the present application illustrate the stand in different orientations and/or arrangements in which, for example, the handrail assembly has a different configuration, the deck sliders are extended, and/or the deck is positioned at a different vertical height.

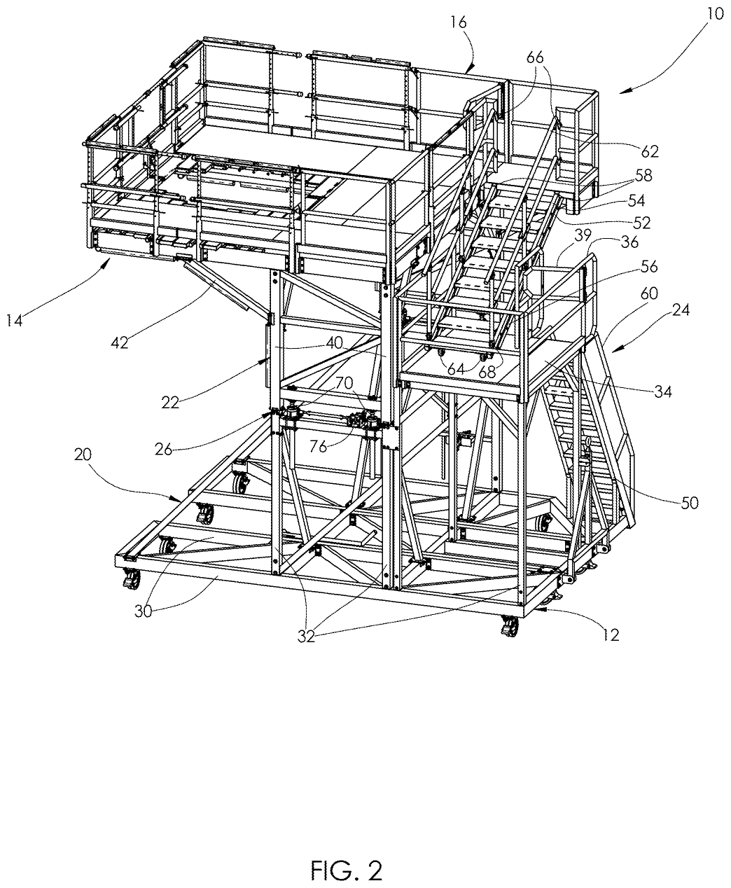

Referring now to FIG. 2, the frame assembly 12 is described in further detail. The frame assembly 12 includes a base portion 20, an upper portion 22, a stair assembly 24, and a lift assembly 26. The frame assembly 12 supports the deck 14 at a vertically elevated position relative to a ground surface. In some embodiments, the base portion 20 and upper portion 22 are integrally constructed to provide a fixed height for the deck 14. In the illustrated embodiment, the frame assembly 12 is configured such that the upper portion 22 is moveable vertically relative to the base portion 20 to adjust a height of the deck 14 within a range of heights. The lift assembly 26 may be interposed between the base portion 20 and upper portion 22 to provide controlled height adjustment of the deck 14.

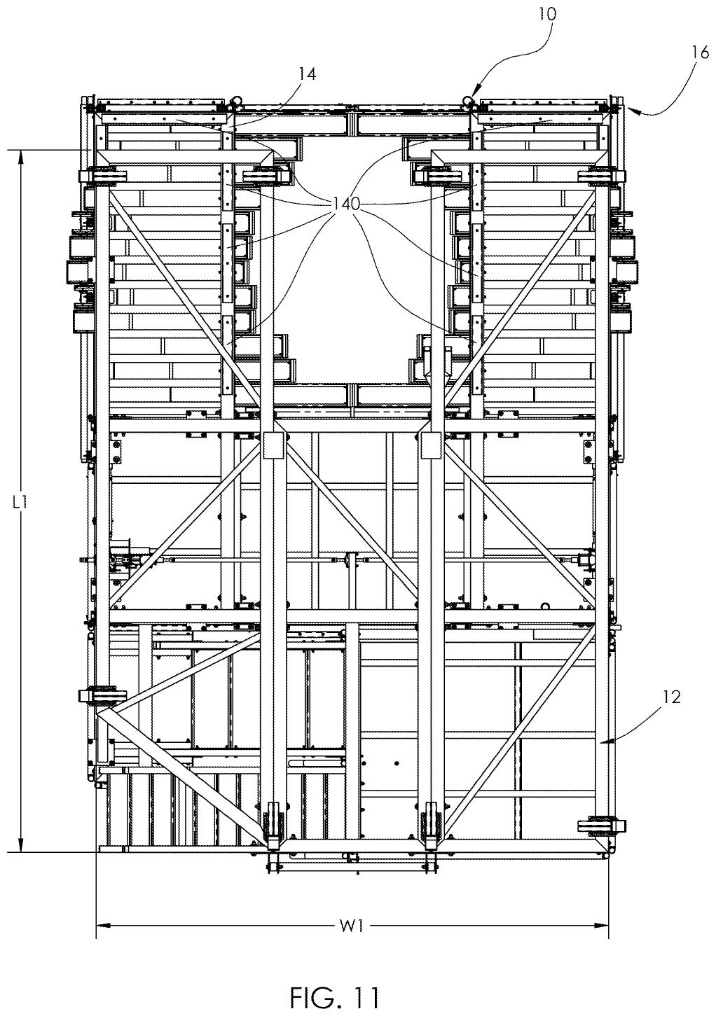

The base portion 20 includes a horizontal frame 30, a first vertical frame 32, a stair platform 34, platform rails 36, and a plurality of rollers 38 mounted to the horizontal frame 30. The base portion 20 may also include a platform gate 39 and have a width W₁ and a length L₁ (see FIG. 11). The horizontal frame 30 defines a footprint at the ground level for the stand 10. The first vertical frame 32 may be supported by or extend from only a portion of the horizontal frame 30. The number of rollers 38 may vary depending on a variety of factors. The rollers 38 may be replaced or supplemented in other embodiments by wheels supported by axles that are mounted to the horizontal frame 30 or first vertical frame 32. The rollers and/or wheels used for moving the stand 10 may include brake devices to help hold the stand 10 in a predetermined position. The frame assembly 12 alternatively may include separate brake structures, lift members or the like that are used to secure the stand 10 in a given position on a ground surface.

The width W₁ typically is in the range of about 10 feet to about 20 feet, and more particularly in the range of about 12 feet to about 16 feet. The width W₁ is typically less than about 15 feet. The length L₁ is typically in the range of about 10 feet to about 25 feet, and more particularly in the range of about 15 feet to about 20 feet. The length L₁ is typically less than about 20 feet. The width W₁ and length L₁ may be selected based on a number of criteria including, for example, the dimensions and weight of the deck 14, how the deck 14 is mounted to the frame assembly (e.g., cantilevered as shown in FIGS. 1-4 or in another orientation), the height of the deck, the materials, weight, height adjustable features, and other characteristics of the frame assembly 12 itself, as well as other features such as the number of flights of stairs, and the like. Preferably, the width and length dimensions of the base portion 20 are selected to be as small as possible, thereby limiting the amount of work space needed for operation of the stand 10.

The upper portion 22 of the frame assembly 12 includes a second vertical frame 40 and braces 42 that support the deck 14. The braces 42 are arranged to assist in holding the deck 14 in a cantilevered orientation relative to the base portion 20 of the frame assembly 12. The braces 42 may be arranged at an angle (e.g., an angle of about 30 degrees to 60 degrees relative to a vertical plane). The braces 42 may extend from the second vertical frames 40 to the deck 14 (e.g., along a bottom side of the deck 14) as shown in FIGS. 1-4.

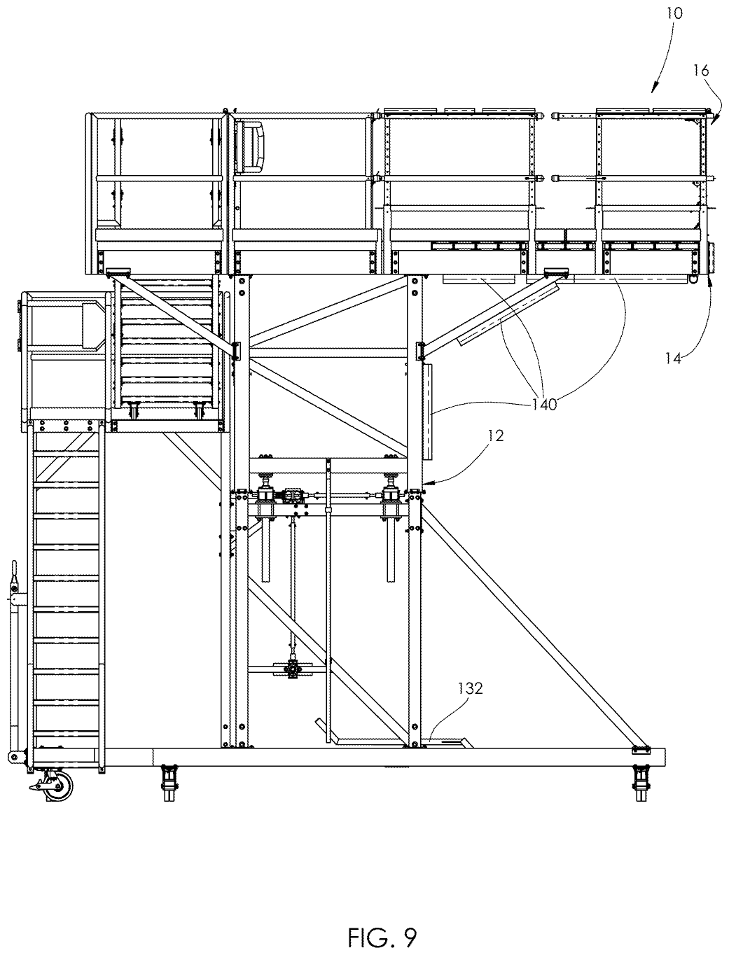

In some embodiments, portions of the base portion 20, upper portion 22 (such as the braces 42), and deck 14 may include bumpers or other shock absorbing material along portions that may contact the vehicle during us. FIGS. 9 and 11 show bumpers 140 positioned at various locations on the stand 10 at locations that will help protect the vehicle in the event of contact with the stand 10.

The second vertical frame 40 may be mounted to the first vertical frame 32 of the base portion 20 with a sliding interface. For example, the vertical members of the second vertical frame 40 may include hollow beams with a rectangular cross-sectional shape having a first cross-sectional area. The first vertical frame 32 may include a plurality of vertical beams with a matching rectangular cross-sectional shape having a second cross-sectional area that is smaller than the first cross-sectional area to facilitate insertion therein.

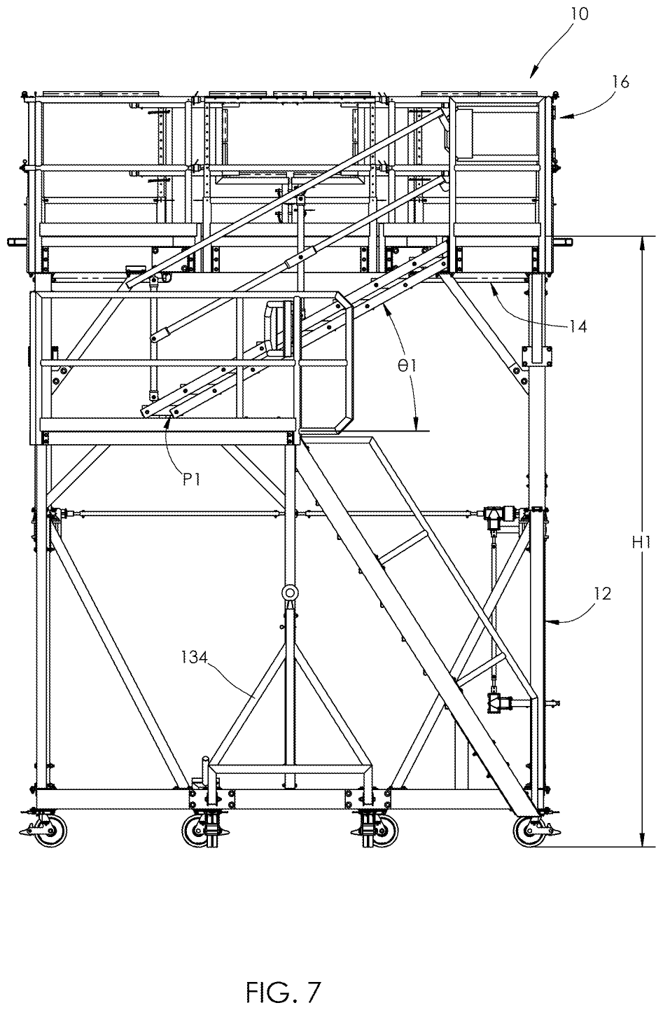

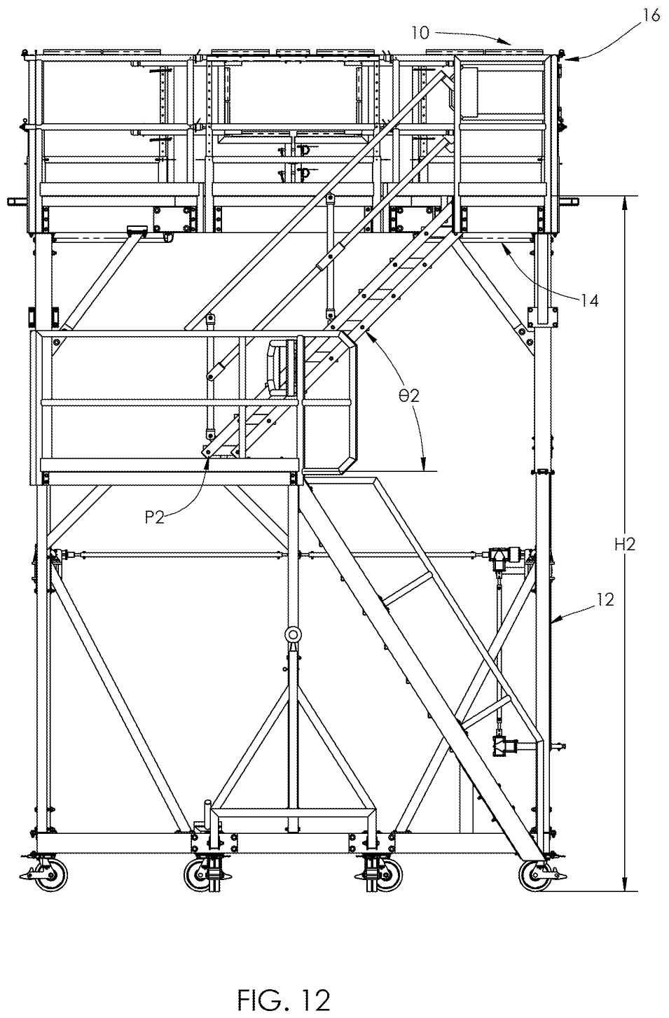

The stair assembly 24 includes first and second flights of stairs 50, 52, first stair rails 60, and second stair rails 62 (see FIG. 7). The first flight of stairs 50 is mounted to the base portion 20 and the stair platform 34. The second flight of stairs 52 may be configured as a “ships ladder” that is arranged at a pitch angle θ₁ in the range of about 50° to about 70°, and having a defined rise height between steps and an opening between risers. The second flight of stairs 52 may be referred to as height adjustable stairs. The second flight of stairs 52 includes an upper end 54 positioned adjacent to the deck 14, a lower end 56 that rests on the stair platform 34, and a pivot connection 58 that provides connection of a second flight of stairs 52 to the deck 14. As the deck 14 raises and lowers by operation of a lift assembly 26, the lower end 56 of the second flight of stairs 52 slides along the top surface of the stair platform 34 while the upper end 54 maintains the pivot connection 58. The second flight of stairs 52 is constructed in a way that automatically adjusts a pitch of the second flight of stairs 52 between angles θ₁ (see FIG. 7) and θ₂ (see FIG. 12) during vertical adjustment of the deck 14. The treads of the second flight of stairs 52 may remain parallel to a ground surface during the automatic adjustment.

The stair assembly 24 is configured to fit within a footprint of the base portion 20 of the frame assembly 12. That is, the stair assembly 24, at least in some embodiments, may remain within a length L₁ and width W₁ of the base portion 20, particularly during use of the stand 10 with a vehicle.

The first stair rails 60 are mounted to the first flight of stairs 50 and the second stair rails 62 are mounted to the second flight of stairs 52. The second stair rails 62 are also pivotally connected at their upper end to the deck handrail assembly 16 at a plurality of pivot connections 66. A lower end of the second stair rails 62 are pivotally connected to the second flight of stairs 52 at a plurality of pivot connections 68. FIG. 7 illustrates the second flight of stairs 52 and second stair rails 62 in a first position P₁ when the deck 14 is at a lower-most position. The deck 14 may have a height H₁ when in position P₁. The second flight of stairs 52 has a first pitch defined by an angle θ₁ when in the position P₁. FIG. 12 shows the second flight of stairs 52 and second stair rails 62 in a second position P₂ when the deck 14 is in its highest adjusted position at a height H₂. FIG. 12 illustrates the second flight of stairs 52 having a steeper pitch defined by an angle θ₂ as compared to the first position P₁. This change in pitch occurs automatically as the deck 14 moves between raised and lowered positions.

The height H₁ typically is in the range of about 10 feet to about 20 feet, and more particularly in the range of about 15 feet to about 16 feet. The height H₁ may be at least 15 feet. The height H₂ typically is in the range of about 15 feet to about 24 feet, and more particularly in the range of about 16 feet to about 20. In some embodiments, the height H₁ may be no greater than about 20 feet. In one example, the deck 14 has a height of about 16 feet 8 inches±1 foot. In other examples, regardless of the minimum or maximum height, the stand may provide a range of height adjustment for the deck 14 of about 6 inches to about 6 feet, and more particularly about 1 foot to about 3 feet.

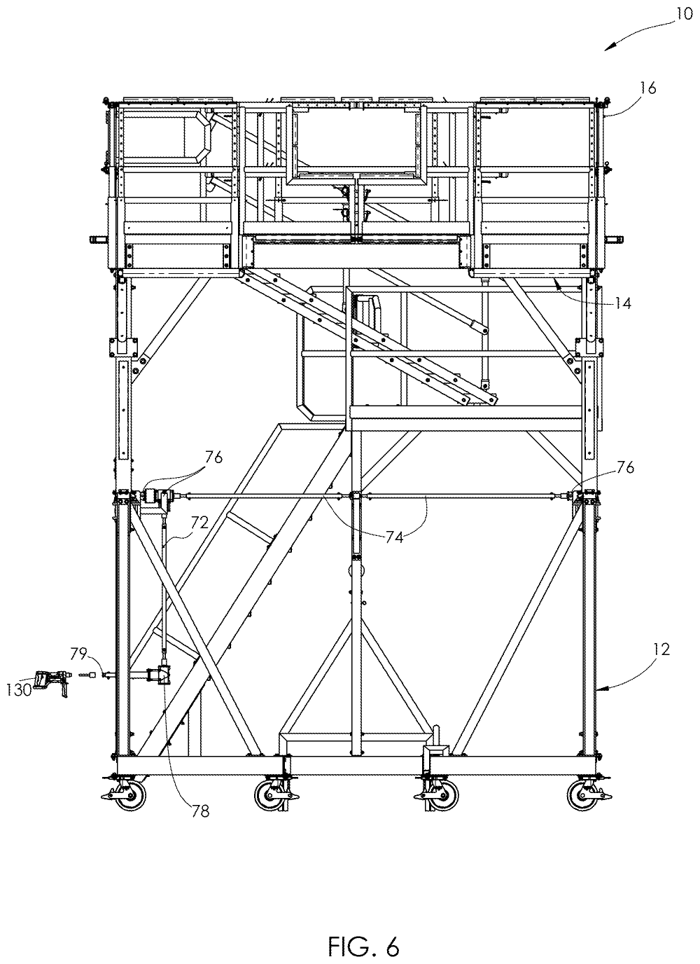

The lift assembly 26 includes a plurality of screw jacks 70, a plurality of vertical links 72, a plurality of horizontal links 74, a plurality of gear boxes 76, and an input transfer box 78 having a rotation input adapter 79 (see FIGS. 2, 4 and 6). The screw jacks 70 are positioned on opposite right and left sides of the frame assembly 12. The vertical links 72 and horizontal links 74, with the gear boxes 76 and transfer box 78, are used to interconnect the screw jacks 70 so that they operate concurrently and in unison with each other based on a rotation input at the adapter 79. The rotation input may be provided using, for example, a drill 130 (see FIG. 6).

Although screw jacks are illustrated in the figures for use in moving the base and upper portions 20, 22 relative to each other, thereby adjusting a height of deck 14, other types of vertical adjustment features may be used to perform a similar function. The use of screw jacks interconnected with a plurality of links and gear boxes may be particularly useful for providing a coordinated vertical adjustment, especially when dealing with the relatively heavy features and cantilevered deck 14 of the stand 10. However, other types of lift mechanisms may be used including, for example, hydraulic jacks and the like.

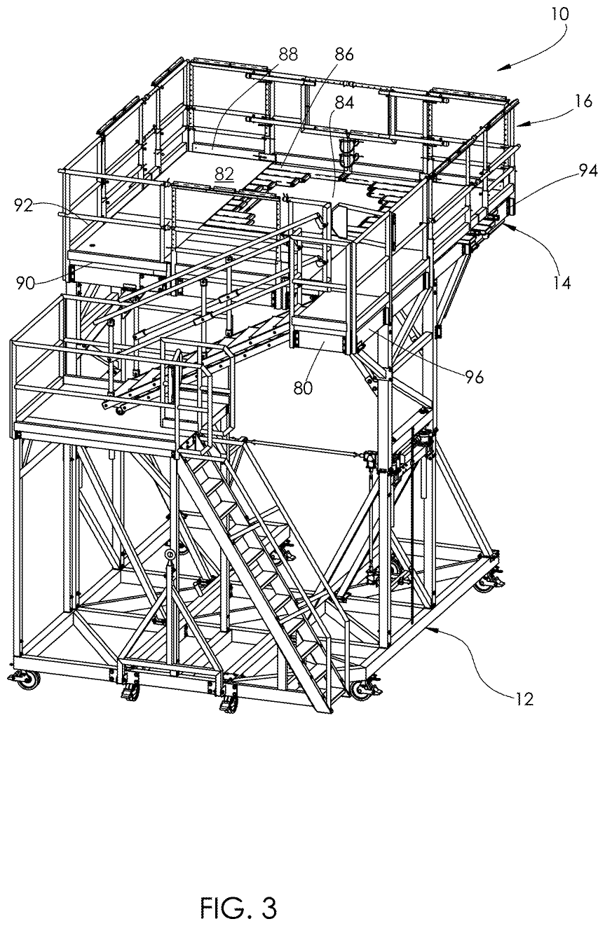

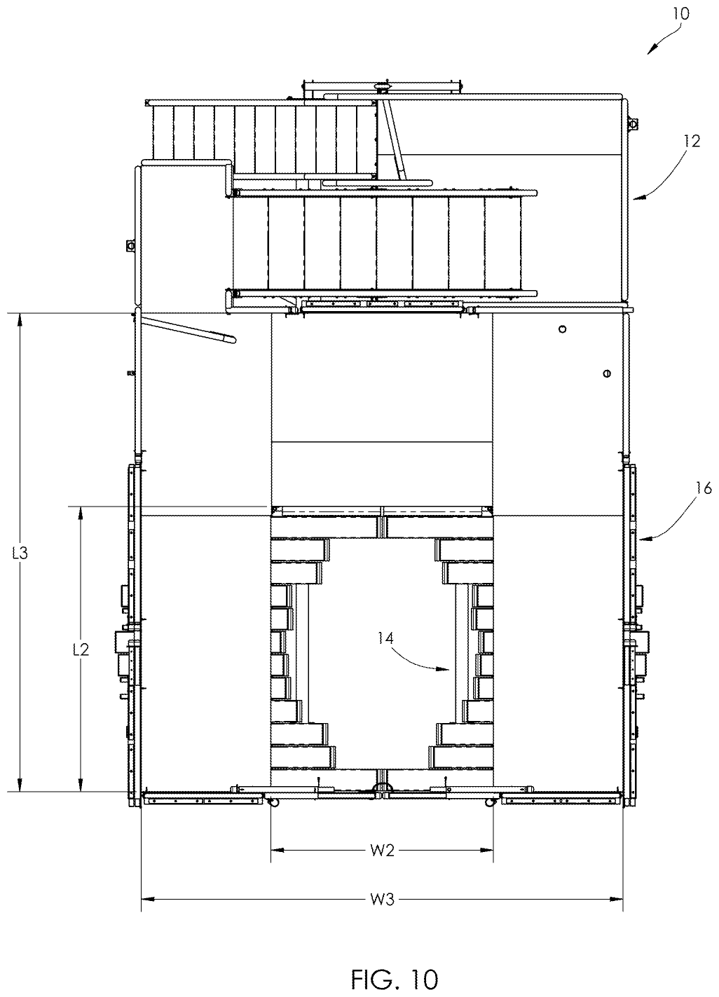

Referring now to FIG. 3, the deck 14 is described in further detail. The deck 14 includes a support structure 80, a platform surface 82 mounted to the support structure 80, a gap 84 having a width W₂ and length L₂ (see FIG. 10), deck sliders 86, front and rear edges 88, 90, right and left side edges 93, 94, and a stair landing 96. The deck 14 is mounted to the upper portion 22 of the frame assembly 12. The deck 14 extends in a cantilevered arrangement relative to the upper portion 22 assisted at least in part by the plurality of braces 42. As described above, the second flight of stairs 52 is pivotally mounted to the deck 14. The second flight of stairs 52 is mounted to the stair landing 96. The stair landing 96 is generally outside of the width W₃ and length L₃ dimensions of the platform surface 82 shown in FIG. 10.

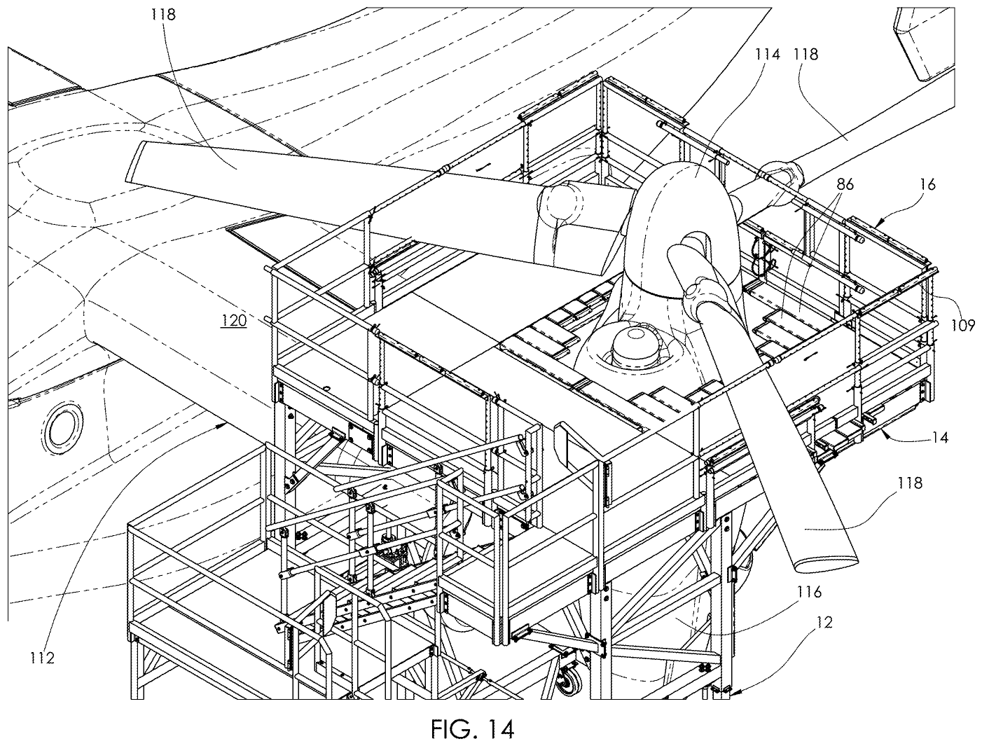

The platform surface 82 defines a work surface upon which workers can stand while performing tasks associated with the vehicle. The platform surface 82 may be increased in size using the plurality of deck sliders 86. The deck sliders 86 may be positioned within the support structure 80 underneath the platform surface 82. The deck sliders 86 may be individually adjustable into and out of the gap 84 as shown in, for example, FIG. 3 and FIG. 14. The deck sliders 86 may be held in their extended and retracted positions with, for example, an interference fit connection to the support structure 80 and platform surface 82. The deck sliders 86 may be configured to removably engage a portion of the vehicle positioned in the gap (e.g., an engine or a fuselage). The deck sliders 86 may extend into position near or against the vehicle components, sliding along a plane or surface bridging a portion of the gap 84. The deck sliders 86 may be operable to move between an open and closed position over the gap 84, adjustable to facilitate relatively safe and efficient access to various sized vehicle components or various positions of a given vehicle component relative to the deck 14. In this manner, the deck sliders 86 may function to form an integral flat surface with the platform surface 82 to close the at least one gap 84 or portions thereof.

The gap 84 has a length L₂ extending rearward from the front edge 88 towards the rear edge 90. The width W₂ is measured in a direction between the right and left side edges 92, 94. The length L₂ typically is in the range of about 4 feet to about 10 feet, and more particularly about 5 feet to about 8 feet. In one embodiment, the length L₂ is about 7 feet. The width W₂ typically is in the range of about 4 feet to about 8 feet, and more particularly about 5 feet to about 7 feet. In one embodiment, the length W₂ is about 6 feet. Deck 14 may have a generally rectangular shape. The length L₃ of the deck 14 typically is in the range of about 10 feet to about 15 feet, and more particularly about 12 feet to about 14 feet. In one embodiment, the length L₃ is about 13 feet. The width W₃ of the deck 14 typically is in the range of about 10 feet to about 15 feet, and more particularly about 12 feet to about 14 feet. In one embodiment, the length W₃ is about 13 feet. The shape and size of the deck 14 and gap 84 may adjusted to accommodate different sizes and shapes of vehicles and or vehicle parts for which the stand 10 is being used.

The deck handrail assembly 16 is mounted to the deck 14 around the front and rear edges 88, 90 and the right and left side edges 92, 94 as well as along a perimeter of the stair landing 96. As described above, a portion of the deck handrail assembly 16 may be removable, such as in the area of the gap 84 along the front edge 88 for purposes of, for example, positioning the stand 10 into close proximity to the vehicle (i.e., moving a portion of the vehicle into the gap 84).

In other arrangements, the deck 14 may be supported around its entire periphery by the frame assembly 12 rather than being cantilevered from a portion of the frame assembly 12 as shown in the figures. In such an arrangement, only portions of the frame assembly 12 positioned vertically below the gap 84 may be removed or reduced in size in order to permit insertion of the portion of the vehicle into the gap and any portion of the vehicle that extends below the gap would not interfere with the frame assembly in a vertical direction within the footprint of the gap 84.

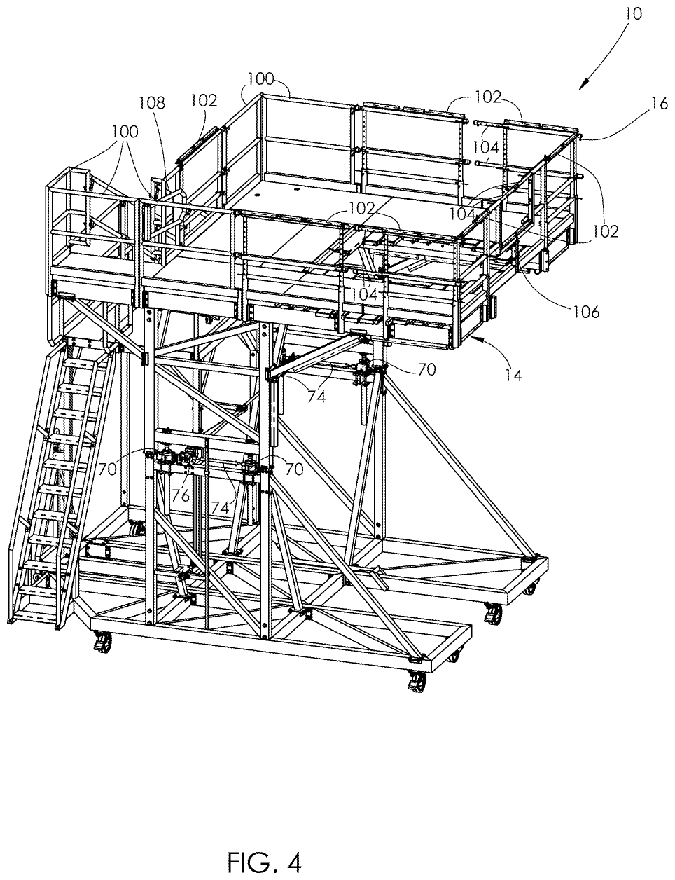

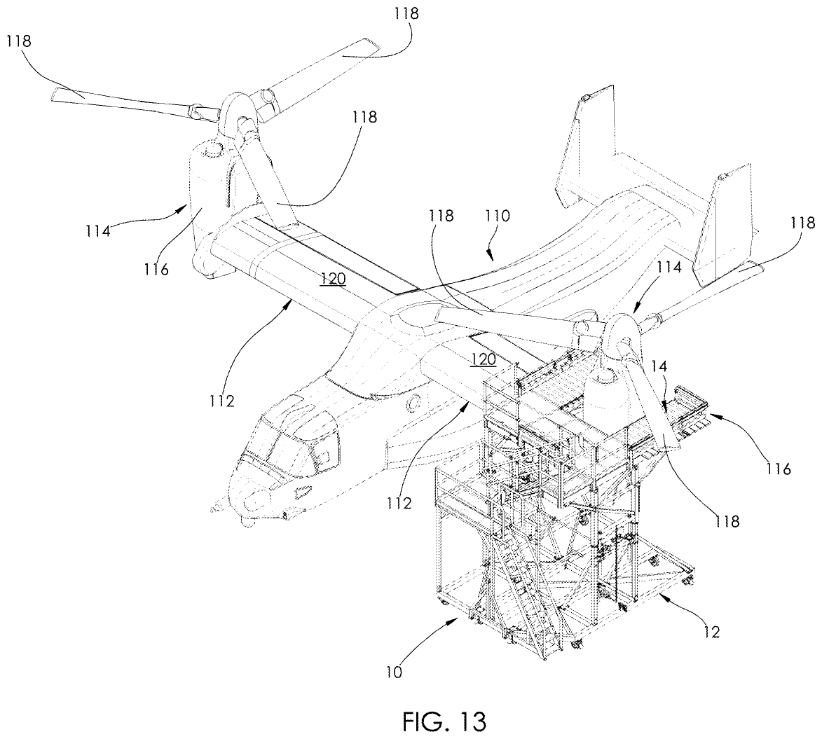

The deck handrail assembly 16 includes a plurality of fixed rails 100, a plurality of height adjustable rails 102, a plurality of horizontal adjustable rails 104, at least one removable gate 106, and at least one swinging gate 108 (see FIG. 4). The fixed rails 100 are positioned at locations around the deck 14 that typically would not interfere with a portion of the vehicle while the stand 10 is initially being positioned adjacent to the vehicle (e.g., with a portion of the vehicle positioned within the gap 84). For example, when using the stand 10 with a V-22 aircraft, the fixed rails 100 are positioned such that they are not going to contact any of the rotor blades of the aircraft when positioning the vertically oriented nacelle of the aircraft engine within the gap 84 from either the front or rear directions (e.g., see FIG. 13).

The height adjustable rails 102 may be adjusted vertically up or down, such as to be positioned at a same height of the fixed rails 102 when in a raised position as shown in FIG. 4, or in a lowered position as shown in FIG. 13. When all of the height adjustable rails 102 are in the lowered position as shown in FIG. 13, the rails 102 are typically out of position for contact with the rotor blades (in the case of a V-22 aircraft) or other aircraft components when the stand is moved into position adjacent to the engine of the aircraft with the nacelle positioned within gap 84 as shown in FIG. 13. Once the stand 10 is positioned as shown in FIG. 13, at least some of the height adjustable rails 102 may be raised to their full height as shown in FIG. 14. Some of the horizontal adjustable rails 104 may be adjusted horizontally in the areas where the rotor blades extend through the deck handrail assembly 16. The horizontal adjustable rails 104 may provide a continuous or near-continuous upper rail around a perimeter of the deck 14 when the deck 14 is in some vertical positions. In other vertical positions, such as the fully elevated position shown in FIG. 12, some of the height adjustable rails 102 and horizontal adjustable rails 104 may interfere with one or more of the rotor blades.

The removable gate 106 may be removed prior to moving the stand 10 into a working position adjacent to the vehicle such as when the engine is positioned within the gap 84 as shown in FIG. 13. After the stand 10 is moved into the working position shown in FIG. 13, the removable gate 106 may be mounted again to the deck 14 as shown in FIG. 14. The removable gate 106 may include one or more horizontal adjustable rails 104. In some embodiments, the gate 106 may include one or more height adjustable rails 102 and/or one or more fixed rails 100.

The swinging gate 108 may be used to control access to the deck 14 and/or the stair assembly 24 at or near the stair assembly 24. Other types of gates or egress devices may be used to provide access to the stair assembly 24 and/or to the working area of deck 14.

At least some of the rails of deck handrail assembly 16 may include a pad, bumper, or other feature 109 (see FIG. 14). The pad 109 may provide padding along those portions of the deck handrail assembly 16 that may otherwise interface with portions of the vehicle (such as surfaces of the rotor blades or nacelle of an engine of an aircraft). In some embodiments, the pad 109 may include aircraft grade rubber bumpers. Such rubber bumpers may be positioned at any location along any of the rails disclosed herein.

The deck handrail assembly 16 may provide an OSHA compliant handrail with a 42 inch top rail and a 21 inch mid rail. The height adjustable rails 102 may be reduced to a minimal height of about 15 inches to about 20 inches above the platform surface 82 of the deck 14. In some embodiments, the height adjustable rails 102 may be adjustable to a plurality of different heights between a fully collapsed position (see FIG. 13) and a fully extended position as shown in, for example, FIG. 14. The collapsed height adjustable rails 102 may be reduced to an even lower height.

The deck handrail assembly 16 may be customized for use with different types of vehicles such as other types of aircraft with different dimensions, orientations for the nacelle and rotor blades of the motor.

The stand 10 may comprise different types of materials having various properties, such as strength, durability, rigidity, wear resistance, shock absorption, and the like to provided optimized performance, cost and other benefits associated with stand 10. In one embodiment, the stand 10 comprises primarily metal materials, but may in other embodiments include polymer, composite or other non-metal materials. In one example, the stand 10 has a weight in the range of about 5,000 pounds to about 8,000 pounds, and more particularly about 5,800 pounds to about 6,400 pounds, such as for the stand 10 described above with reference to FIGS. 1-15. Further, the stand 10 may be designed to support a predetermined number of workers, such as 3 to 10 workers, and more particularly 4 workers.

FIGS. 13 and 14 illustrate an aircraft 110 having wings 112 and engines 114. The engines 114 include nacelles 116 and rotor blades 118. The wing 112 may have a top surface 120. FIGS. 13 and 14 illustrate positioning of the deck 14 above the top surface 120 of the wings 112. This arrangement is possible at least in part because of the cantilevered arrangement of the deck 14 relative to the frame assembly 12. A portion of the frame assembly 12 (i.e., a portion of base portion 20) may be positioned vertically below the wing 112 while the deck 14 is positioned vertically above the wing 112. In other arrangements, a bottom surface of the deck 14 may be positioned at a height that is greater than a height of the top surface of the wing 112, while the portion of the frame assembly 12 positioned below the cantilevered deck 14 (i.e., a portion of the base portion 20) is positioned at a height that is lower than a bottom surface of the wing 112.

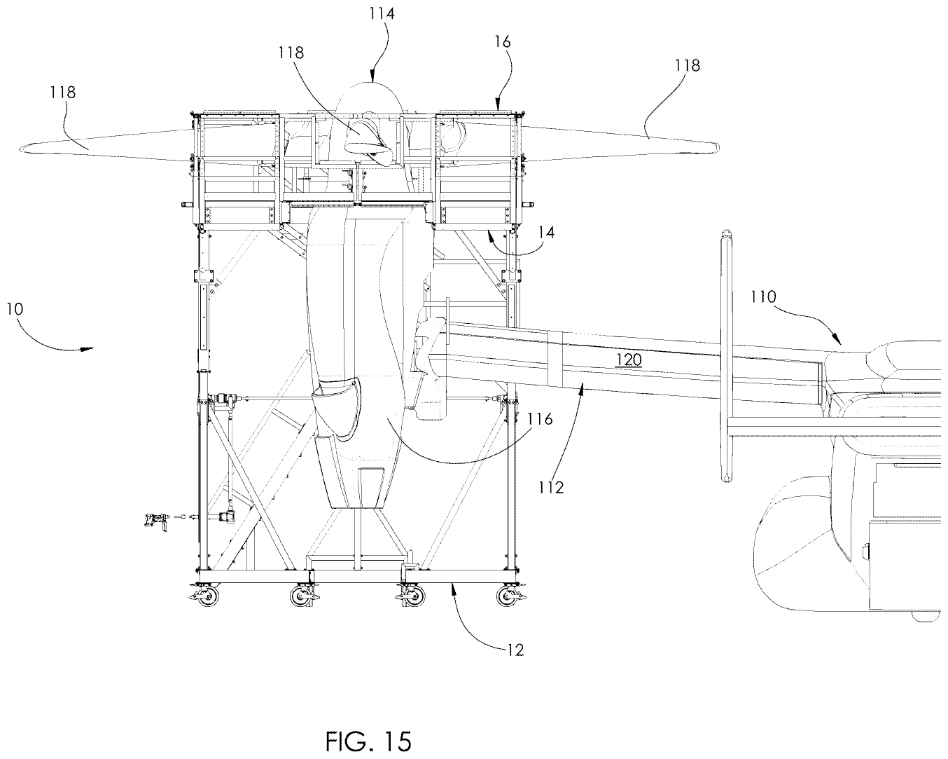

In the embodiment shown in FIGS. 13 and 14, the deck 14 is positioned vertically between the top surface 120 of wing 112 and the bottom surface of one or more of the rotor blades 118. FIG. 15 shows a side view of the aircraft 110 and stand 10 to further illustrate the relative heights of features of the stand 10 and aircraft 110. In other embodiments, the deck 14 is positioned at a height that is greater than a height of the top surface 120 of the wing and the platform surface 82 of the deck 14 is positioned at a height that is lower than a height of the rotor blades 118. In some embodiments, the height adjustable rails 102, when in a retracted position as shown in FIG. 13, may be positioned below the rotor blades 118 while other portions of the deck handrail assembly 16 (e.g., the fixed rails 100) may extend to a height that is at or above the height of the rotor blades 118.

The arrangement of the deck 14 relative to the wing and rotor blades shown in FIGS. 13 and 14 may provide a number of advantages related to providing workers with work spaces adjacent to the nacelle 116 and rotor blades 118 of the engine 114. The arrangement of the deck 14 cantilevered over a top surface of the wing 112 and positioned vertically below one or more of the rotor blades 118 while the nacelle 116 is positioned at least partially within gap 84 of the deck 14 may assist in optimizing the amount of work space available for a worker in proximity to the engine 114 on a relatively flat surface provided by platform surface 82 and deck sliders 86 with relative safety provided by the deck handrail assembly 16. The adjustability of the deck handrail assembly 16, including removal of the removable gates 106 and collapsibility of the height adjustable rails 102 and horizontal adjustment of the horizontal adjustable rails 104, may provide for numerous customizable arrangements for the handrail assembly to optimize safety for workers in and around the engine 114 while also accommodating moving the stand 10 into a working position relative to the aircraft 110, height adjustments of the deck 14, and orientation of the rotor blades 118 relative to the stand 10.

FIG. 13 shows a stand 10 positioned from a front side of an aircraft engine 114. In other embodiments, it may be possible to position the stand from either a left side or a right side of the engine 114 (e.g., if the gap 84 is increased in size and/or the deck 14 has further height adjustability), or from a rear side. In side oriented arrangements, it may be possible to move the deck 14 vertically through a greater range of motion to provide access to additional portions of the nacelle 116 and/or rotor blades 118. In one example, the deck 14 may be adjustable to a height that is at or below the top surface 120 of the wing 112 while still including at least a portion of the engine 114 within the gap 84.

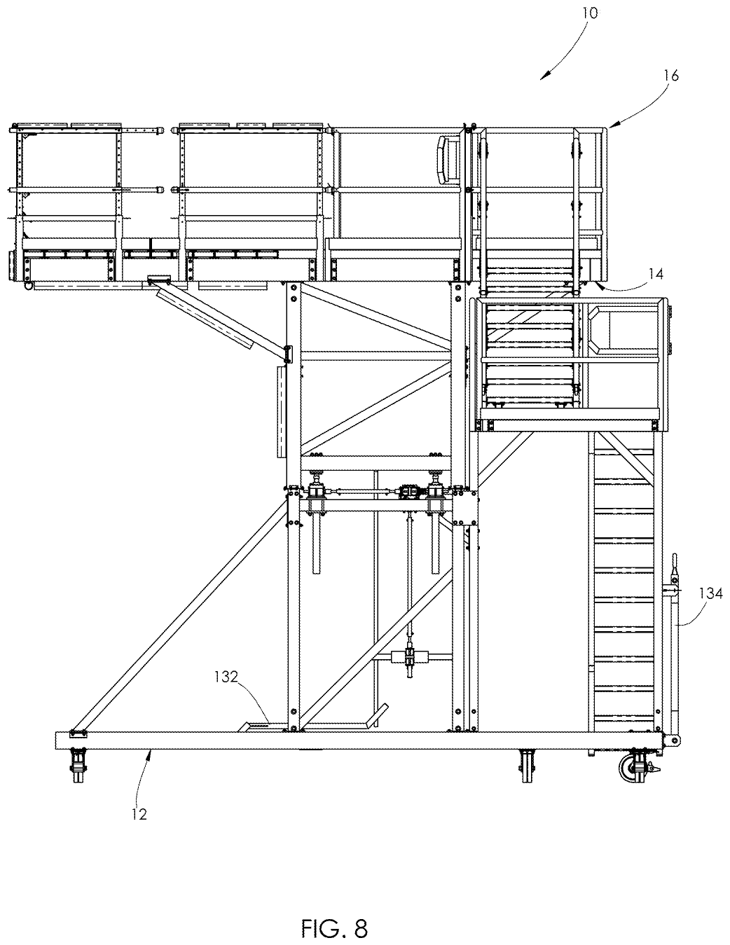

The stand 10 may also include a repositioning tool 132 (see FIGS. 8 and 10). The tool 132 may operate to reposition the rollers 138 to a particular direction. The repositioning tool 132 may be mounted to the base portion 20 of the frame assembly 12. In some embodiments, the repositioning tool 132 may be removable from the base portion 20. The repositioning tool 132 may be operable to move multiple rollers 138 at a given time.

The stand 10 may also include a tow bar 134 (see FIGS. 7 and 8). The tow bar 134 may be attached to the base portion 20. The tow bar may be movable between a stowed position (e.g., the vertically oriented position shown in the figures), and an operational position (e.g., a horizontal orientation suitable for connecting to a towing vehicle).

The dimensions, shapes, sizes, adjustability features, and the like may be customized, altered or otherwise changed in order to accommodate use with different shapes, sizes and types of vehicles. Such modifications are within the spirit and scope of the present disclosure.

Unless otherwise explained, any technical terms used herein have the same meaning as commonly understood by one of ordinary skill in the. The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described herein. The term “comprises” means “includes.” All publications, patent applications, patents, and other references mentioned herein are incorporated by reference in their entirety for all purposes. The materials, methods, and examples are illustrative only and not intended to be limiting.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. Often, the width of an object is transverse the object's length.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A portable aircraft maintenance stand, comprising:
a frame assembly having a base portion and an upper portion;
a deck mounted to the upper portion of the frame assembly, the deck having a cantilevered portion, the deck having a gap configured to receive an engine of an aircraft such that the deck at least partially wraps around the engine, the cantilevered portion of the deck being configured to be positioned vertically above a wing of the aircraft, the engine being mounted to the wing, while the base portion of the frame assembly is positioned vertically below the wing.

2. The portable aircraft maintenance stand of claim 1, wherein the upper portion of the frame assembly is vertically adjustable relative to the base portion.

3. The portable aircraft maintenance stand of claim 2, wherein the frame assembly includes first and second stair sections, at least one of the stair sections being automatically adjustable in response to the upper portion being adjusted vertically relative to the base portion.

4. The portable aircraft maintenance stand of claim 1, wherein the frame assembly further comprises a screw jack assembly operable to vertically adjust the upper portion relative to the base portion.

5. The portable aircraft maintenance stand of claim 4, wherein the screw jack assembly includes at least four screw jacks that are linked together and operably concurrently using a single rotation input.

6. The portable aircraft maintenance stand of claim 1, further comprising a handrail assembly mounted to the deck, the handrail assembly including at least one height adjustable section.

7. The portable aircraft maintenance stand of claim 6, wherein the handrail assembly includes at least one width adjustable member.

8. The portable aircraft maintenance stand of claim 6, wherein the handrail assembly includes at least one removable section.

9. The portable aircraft maintenance stand of claim 1, wherein the deck includes a plurality of deck sliders, at least some of the deck sliders being adjustable into and out of the gap to adjust a size of the gap.

10. The portable aircraft maintenance stand of claim 1, wherein the engine includes a vertically oriented nacelle and a plurality of horizontally oriented rotor blades, and the deck is positioned vertically below the rotor blades.

11. The portable aircraft maintenance stand of claim 1, wherein the frame assembly has a maximum width of less than 15 feet and a maximum length of less than 20 feet.

12. The portable aircraft maintenance stand of claim 1, wherein the deck is adjustable in height between about 15 feet and about 20 feet.

13. A method of operating a portable maintenance stand relative to an aircraft, the aircraft having a wing and an engine mounted to the wing, the method comprising:
providing a portable aircraft maintenance stand having a frame assembly and a deck, the deck mounted to the frame assembly and having a gap;
positioning the stand adjacent to the aircraft with a portion of the deck positioned vertically higher than a top surface of the wing and a portion of the engine positioned in the gap.

14. The method of claim 13, wherein the engine includes a vertically oriented nacelle and a plurality of horizontally oriented rotor blades, the nacelle being positioned in the gap, and the deck being positioned vertically below the rotor blades.

15. The method of claim 13, wherein the deck includes a plurality of deck sliders, and the method further comprises adjusting at least some of the deck sliders into and out of the gap to reduce a space between the deck and the engine within the gap.

16. The method of claim 13, wherein the frame assembly includes a base portion and an upper portion, the deck being mounted to the upper portion, the method further comprising vertically adjusting the upper portion relative to the base portion to adjust a height of the deck relative to the aircraft.

17. The method of claim 16, wherein the frame assembly includes at least one flight of stairs, the method including automatically changing a pitch of the stairs when the upper portion is vertically adjusted relative to the base portion while treads of the stairs remains parallel to a ground surface.

18. The method of claim 13, wherein the stand further comprises a handrail assembly mounted to the deck, the method further comprising adjusting or removing at least a portion of the handrail assembly prior to and after positioning the portion of the engine in the gap.

19. A portable aircraft maintenance stand, comprising:
a horizontally oriented deck;
a handrail assembly extending around a perimeter of the deck;
a frame assembly supporting the deck;
at least one flight of stairs providing access to the deck;
wherein the deck is configured to:
at least partially extend around a nacelle of an engine of an aircraft;
extend between a horizontally oriented rotor blade of the engine and a top surface of a wing of the aircraft.

20. The portable aircraft maintenance stand of claim 19, wherein the frame assembly is operable to vertically adjust a height of the deck.
